(19) United States
(12) Patent Application Publication
(10) Pub. No.: US 2009/0087236 A1
(43) Pub. Date: Apr. 2, 2009

(54) PAPER ROUTE SWITCHING APPARATUS

(76) Inventors: Chang-Lung Yu, Hsinchu City (TW); Tien-Ho Hsu, Hsinchu City (TW); Yu-Jen Tsao, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/864,919

(22) Filed: Sep. 29, 2007

(51) Int. Cl. G03G 15/00; G03G 21/00

(52) U.S. Cl. 399/371; 399/361

(57) ABSTRACT

A disk having one or more indentations is configured at one end of a driving shaft and has interaction with an extension arm configured at a corresponding end of a switch shaft for switching the medium conveying route in an image system. When the driving shaft drives the disk to rotate along different directions, the indentation on the disk provides the extension arm room for the disk to guide the extension arm to switch its position between a first position and a second position. A plurality of switch gates on the switch shaft also switch to different positions corresponding to the extension arm such that the conveying route of a medium can be switched between a first route and a second route.

### BACKGROUND OF THE INVENTION

1. Field of the Invention

The present invention relates to a paper route switching apparatus, and more specifically, to a paper route switching apparatus activated by rolling of rollers in a duplex printing/scanning business machine.

2. Description of the Prior Art

As images or documents keep up with the trend of multiplicity and delicacy, more and more image systems become multifunctional media centers integrated with copying, printing, scanning, and faxing. Image systems such as copiers, scanners, printers, fax machines, or multifunctional business machines usually equip with functions of automatic duplex scanning (as input function) or printing (as output function), or automatic duplex input/output device with which functions and provide more powerful processing speed with duplex input/output documents without manual switching the documents.

There are many different types of automatic input/output devices integrated into image systems at present. The automatic input/output device performs duplex input/output by switching the conveying route of the paper (or other forms of media) so that the paper can face the core image input/output component, such as the printhead of a printer or the light reading head of a scanner, with different sides. By applying the above principle of duplex input/output, the conventional techniques adapt electrical-mechanical control by implementing light sensors on the paper conveying routes for sending electrical signal to a solenoid when detecting the end or a particular position of a paper and the solenoid controlling a ‘route switching gate’ to switch the conveying route of the paper. For example, the U.S. Pat. Nos. 5,784,680 and 6,513,805 use one solenoid incorporating with sensors and control logics to control one switching gate for switching the paper conveying route. The American patent application 2002/0054382 uses two solenoids incorporating with sensors and control logics to control two switching gates for switching the paper conveying route. Additionally, since most image systems usually have paper conveying route, route for movement of the image input/output core component, paper ejecting route, and paper switching route formed by many closely assembled gear sets, motors, and idlers, other conventional techniques use combination of multiple mechanisms to perform paper conveying route switching. For example, the U.S. Pat. No. 6,307,614 uses two different gates incorporating with the idler for switching the paper conveying route.

The prior art electrical-mechanical switching mechanism for paper conveying route, however, requires extra electrical components (such as the solenoids, the sensors, and corresponding control logics) and more than one switching gate, which raises the cost of manufacturing and the complexity of the overall system. Secondly, compared to mechanical components, electrical components are high-sensitive components and cause more maintenance problems. Finally, for the conventional switching mechanism for paper conveying route by using gears, gates, and idlers, too many mechanisms and mechanical components bring to the rising of design cost, complexity of the structure and higher noise of the image systems during operation.

### SUMMARY OF THE INVENTION

The present invention provides a paper route switching apparatus for switching the medium conveying route of an image system from a first route to a second route, the paper route switching apparatus comprises a driving shaft and a switch shaft. The driving shaft comprises a circular disk configured at one end of the driving shaft and capable of rotating with the driving shaft. The circular disk comprises an indentation. The switch shaft is capable of selectively rotating to a first position or a second position. The switch shaft comprises an extension arm and a switch gate. The extension arm extends from one end of the switch shaft, abuts on the perimeter of the circular disk, and is capable of reaching into the indentation when the circular disk rotates with the driving shaft and being guided by the indentation for switching the switch shaft from the first position to the second position. The switch gate radially extends from the switch shaft and is capable of selectively lying at the first route or the second route when the switch shaft selectively rotates to the first position or the second position.

The present invention also provides an image system having paper route switching apparatus and a first route, a second route and a third route. The image system comprises a conveying roller set, a first sensor, and a paper route switching apparatus. The conveying roller set is for conveying an image medium to proceed in the first route. The first sensor is configured on the second route for detecting an end of the image medium. The paper route switching apparatus comprises a driving shaft and a switch shaft. The driving shaft is capable of rotating along a first direction or a second direction and comprises a circular disk configured at one end of the driving shaft and capable of rotating with the driving shaft. The circular disk comprises an indentation. The switch shaft is capable of selectively rotating to a first position or a second position. The switch shaft comprises an extension arm and a switch gate. The extension arm extends from one end of the switch shaft, abuts on the perimeter of the circular disk, and is capable of reaching into the indentation when the circular disk rotates with the driving shaft. The switch gate radially extends from the switch shaft and is capable of selectively lying at the second route or the third route when the switch shaft selectively rotates to the first position or the second position. When the driving shaft rotates along the first direction, the indentation is for guiding the extension arm and switching the switch shaft from the second position to the first position and the image medium proceeds from the first route to the second route. When the driving shaft rotates along the second direction, the indentation is for guiding the extension arm and switching the switch shaft from the first position to the second position and the image medium proceeds from the first route to the third route.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a first exemplary embodiment of the paper route switching apparatus according to the present invention.

FIG. 2 and FIG. 3 are illustrations of two different relative positions between the extension arm and the switch shaft of the present invention.

FIG. 4 and FIG. 5 are illustrations of different paper conveying routes when the paper route switching apparatus 100 is in different positions.

FIG. 6 is an illustration of the paper route switching apparatus switching from the first position to the second position.

FIG. 7 is an illustration of the paper route switching apparatus switching from the second position back to the first position.

FIG. 8 is an illustration of a second exemplary embodiment of the paper route switching apparatus according to the present invention.

FIG. 9 is an illustration of a third exemplary embodiment of the paper route switching apparatus according to the present invention.

FIG. 10 is an illustration of another view of the third exemplary embodiment in FIG. 9.

FIG. 11 is an illustration of a fourth exemplary embodiment of the paper route switching apparatus according to the present invention.

FIG. 12 is an illustration of a fifth exemplary embodiment of the paper route switching apparatus according to the present invention.

FIG. 13 illustrates a route when the image system with paper route switching apparatus performs input/output on the first side of the paper.

FIG. 14 illustrates a route when the image system performs input/output on the second side of the paper.

FIG. 15 illustrates a route when the image system performs sorting of the papers.

### DETAILED DESCRIPTION

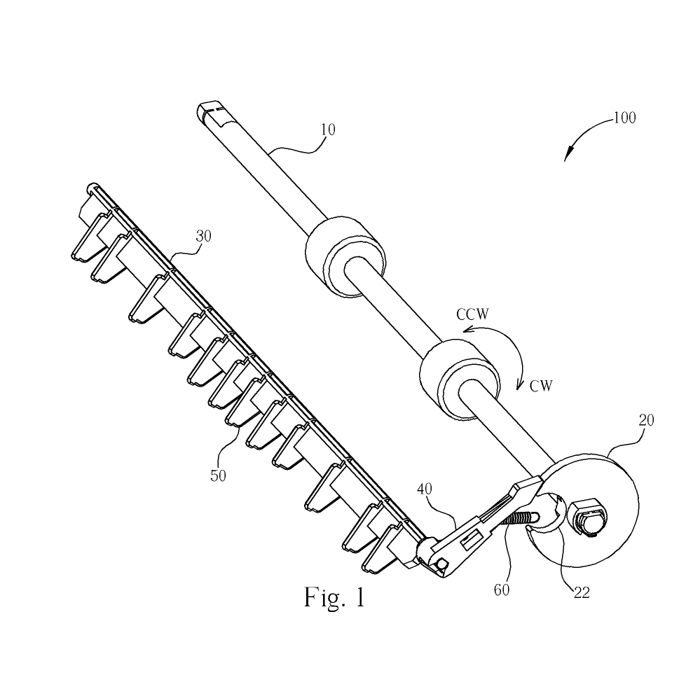

Please refer to FIG. 1. FIG. 1 is an illustration of a first exemplary embodiment of the paper route switching apparatus 100 using a circular disk having an indentation for switching paper route according to the present invention. The paper route switching apparatus 100 is available for image systems such as copiers, scanners, printers, fax machines, and multifunctional business machines to perform paper route switching during scanning, printing, or copying. The paper route switching apparatus 100 comprises a driving shaft 10 and a switch shaft 30. The driving shaft 10 receives power from a power source (such as a motor) of the image system incorporating with gear set. In the exemplary embodiment, the driving shaft 10 is capable of rotating along a first direction (the clockwise direction CW in FIG. 1) or a second direction (the counterclockwise direction CCW in FIG. 1). A circular disk 20 is configured at one end of the driving shaft 10 and is capable of rotating with the driving shaft 10 along the first direction or the second direction. The switch shaft 30 is for switching the paper conveying route and comprises one or more switch gates 50 radially extending from the switch shaft 30. At one end of the switch shaft 30 corresponding to the circular disk 20 of the driving shaft 10, an extension arm 40 extends from the switch shaft 30 and is capable of abutting on the perimeter of the circular disk 20. A recovery element (spring) 60 connects between the extension arm 40 and the housing of the image system (not shown in the figure).

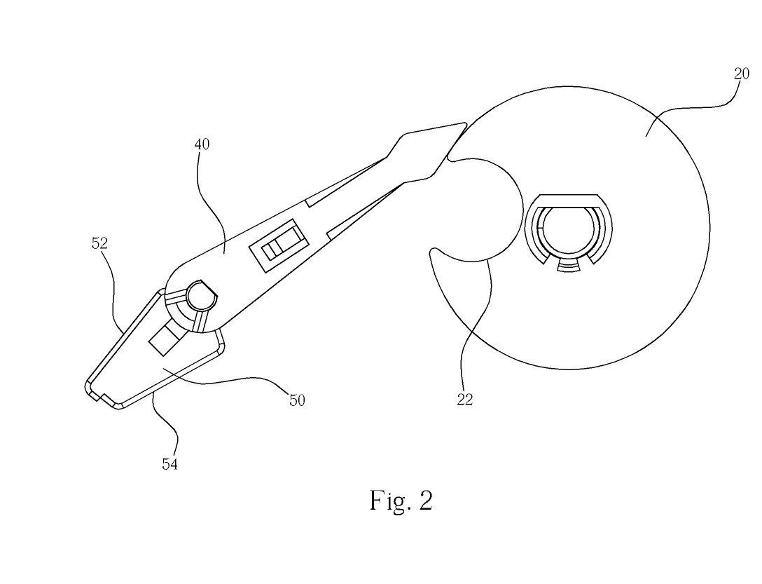

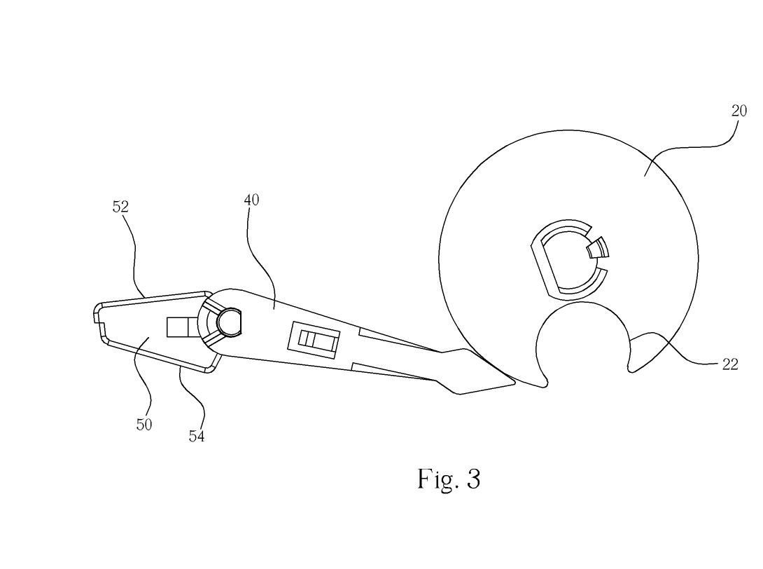

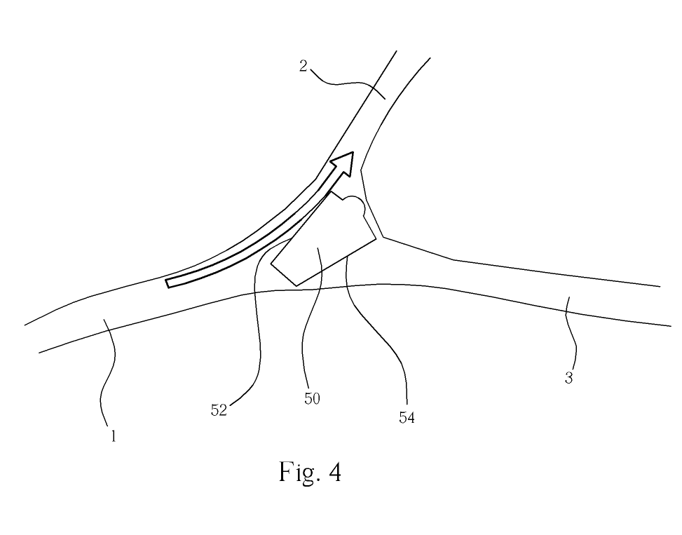

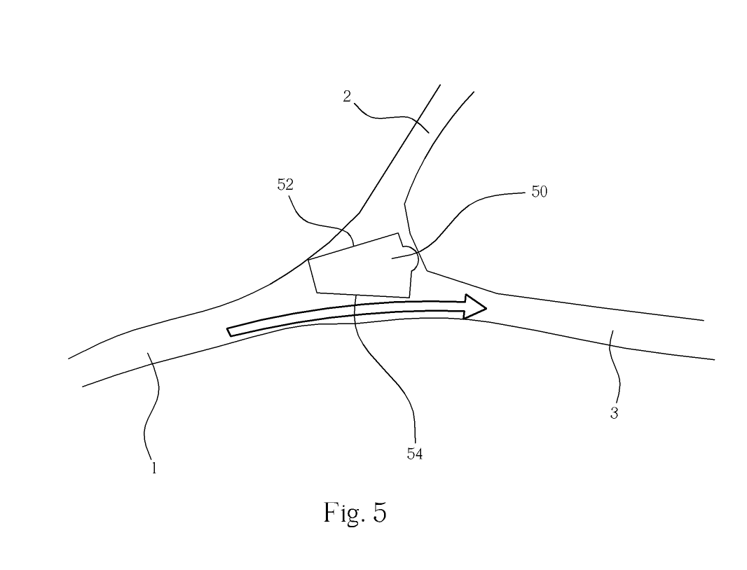

Please refer to FIG. 2 and FIG. 3. FIG. 2 and FIG. 3 are illustrations of two different relative positions between the extension arm 40 and the switch gate 50 of the switch shaft 30 of the present invention. The switch gate 50 comprises a first surface 52 and a second surface 54. Please also refer to FIG. 4 and FIG. 5. FIG. 4 and FIG. 5 are illustrations of different paper conveying routes when the paper route switching apparatus 100 is in different positions. FIG. 4 represents a first position in FIG. 2, FIG. 5 represents a second position in FIG. 3, and the switch shaft 30 (as well as the extension arm 40 and the switch gate 50) is capable of selectively rotating to the first position or the second position. When the extension arm 40 and the switch shaft 30 are in the first position as in FIG. 2, the first surface 52 of the switch gate 50 lies on the route 2 and the paper (not shown in the figure) proceeds from route 1 to route 2. When the extension arm 40 and the switch shaft 30 are in the second position as in FIG. 3, the second surface 54 of the switch gate 50 lies on the route 3 and the paper (not shown in the figure) proceeds from route 1 to route 3.

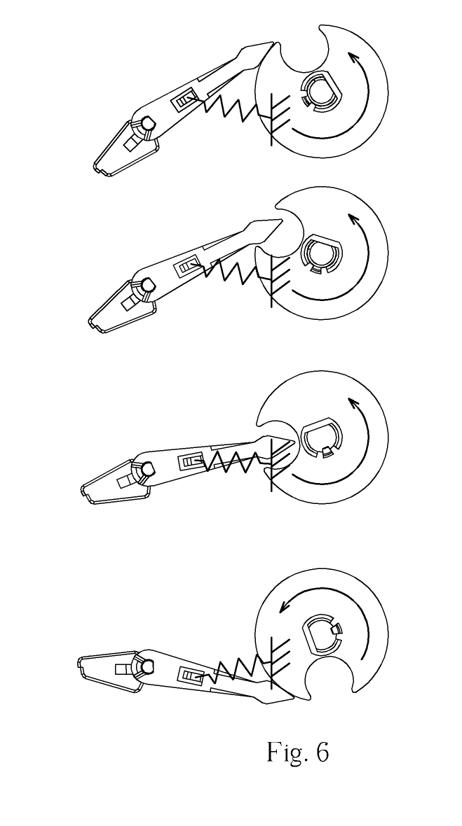

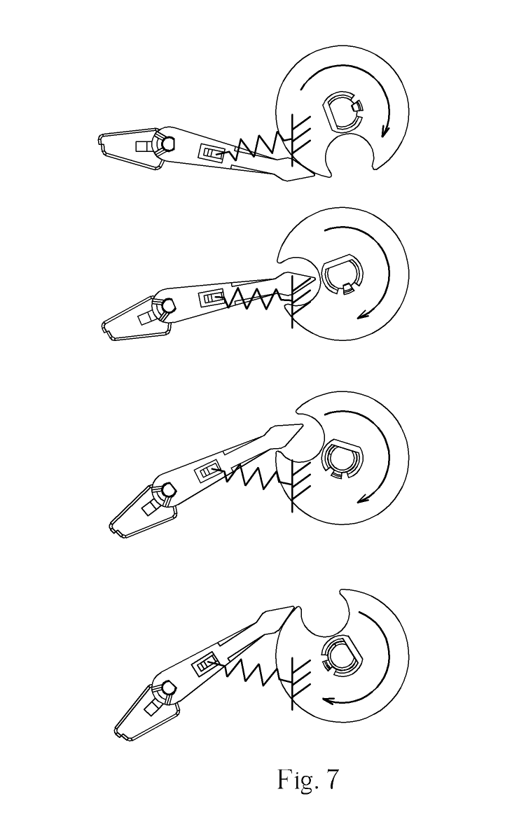

The paper route switching apparatus 100 of the present invention brings the extension arm 40 and the switch shaft 30 to rotate with an indentation 22 on the circular disk 20 and by doing so, the switch gate 50 switches to the first position or the second position and the paper conveying route is alternated. Please refer to FIG. 6 and FIG. 7. FIG. 6 is an illustration of successive movements of the paper route switching apparatus 100 switching from the first position to the second position when the paper route switching apparatus 100 rotates along the first direction (CCW) shown in FIG. 1. The extension arm 40 is capable of abutting on the perimeter of the circular disk 20 due to the recovery element 60. Viewing from top to bottom, the indentation 22 approaches to the extension arm 40 when the circular disk 20 rotates along the first direction and allows the extension arm 40 to reach into when the circular disk 20 keeps rotating along the first direction. The extension arm 40 is then guided by the indentation 22 to the second position at the bottom. Once the extension arm 40 is in the second position, the paper conveying route switches from route 1 proceeding to route 2 in FIG. 4 to route 1 proceeding to route 3 in FIG. 5. Similarly, when the paper route switching apparatus 100 rotates along the second direction (CW) shown in FIG. 1, the successive movements in FIG. 7 shows that the indentation 22 of the circular disk 20 guides the extension arm 40 from the second position to the first position, which the detailed description is omitted for brevity. With the indentation 22 of the circular disk 20, the paper route switching apparatus 100 of the present invention is capable of switching the switch shaft 30 between different positions with simple mechanism and the switch gate 50 on the switch shaft 30 can selectively lie on different routes.

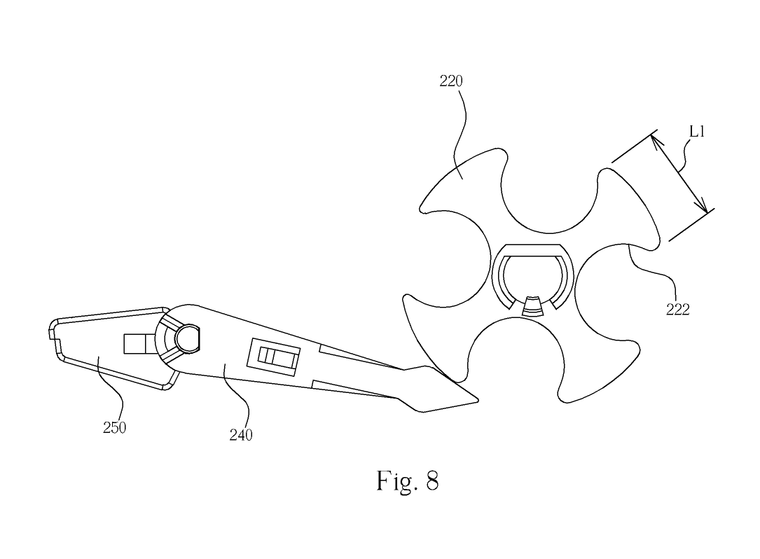

Please refer to FIG. 8. FIG. 8 is an illustration of a second exemplary embodiment of the paper route switching apparatus according to the present invention. Most image systems present their performance index by ‘PPM’, or (input/output) page per minute; therefore, more than one indentation 222 are formed on the circular disk 220 in the second exemplary embodiment to promote the switching rate of the paper (also taking other routes inside the image system into consideration). Different from the first exemplary embodiment, the extension arm 240 of the second exemplary embodiment reaches into the indentation 222 only when the circular disk 220 rotates for L1 along its circumference, which speeds up switching the switch gate 250 between different positions.

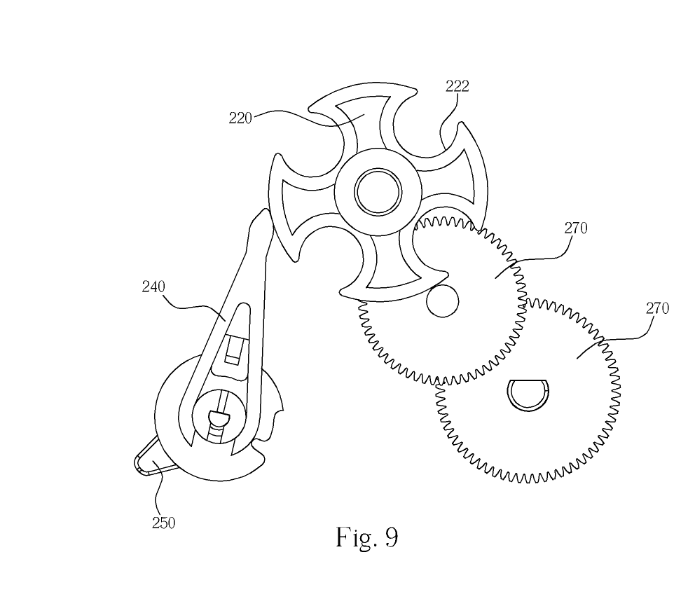

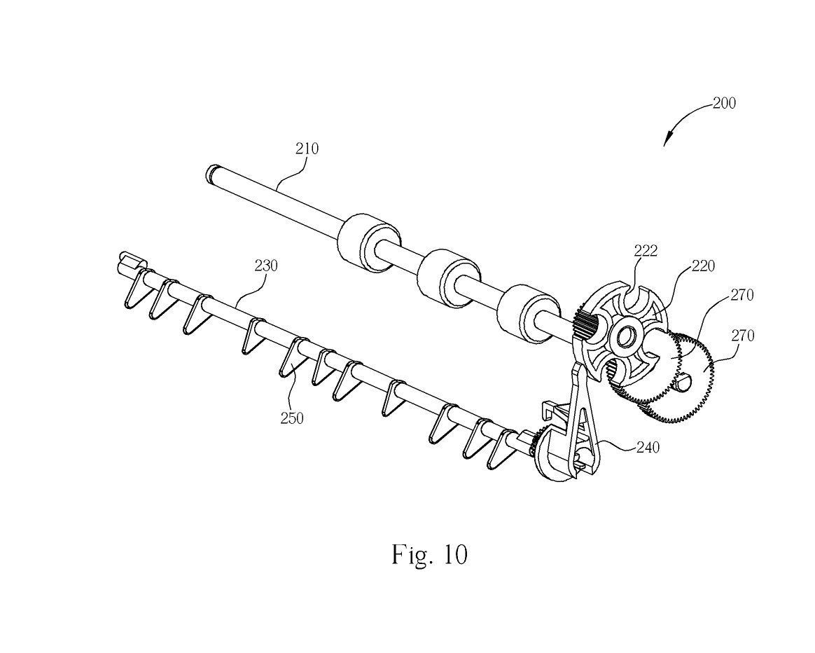

Besides adding more indentations 222 to speed up the switching rate of the switch gate 250, the present invention accelerates the switching rate by configuring a transformation gear set on the driving shaft. Please refer to FIG. 9 and FIG. 10. FIG. 9 shows an illustration of a third exemplary embodiment of the paper route switching apparatus 200 according to the present invention, which allows the driving shaft 210 to rotate in a faster speed (or slower speed if some special design purposes are considered) than that of the first or the second exemplary embodiment by configuring a transformation gear set 270 on the driving shaft 210. FIG. 10 is an illustration of another view of the third exemplary embodiment in FIG. 9.

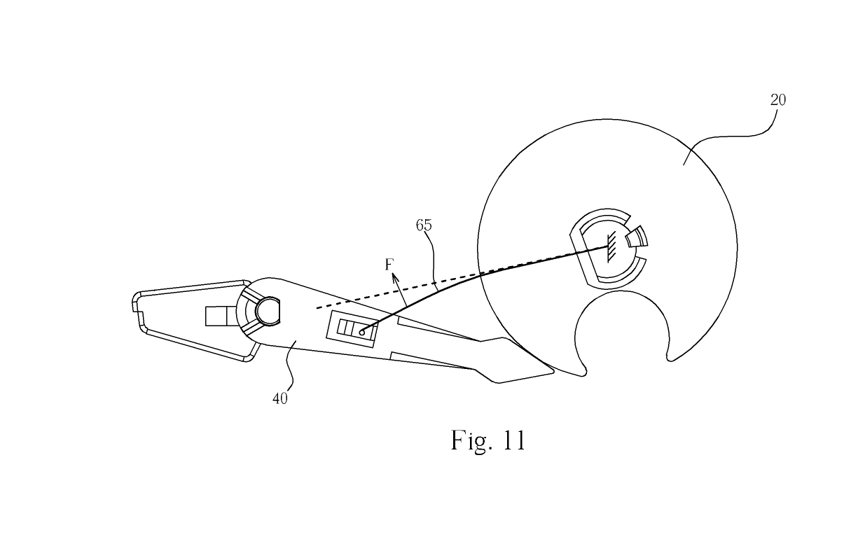

Additionally, the extension arm 40 in the first exemplary embodiment has to keep abutting on the perimeter of the circular disk 20 such that the indentation 22 can guide the extension arm 40 to switch between different positions. The recovery element 60 in the first exemplary embodiment ensures that the extension arm 40 maintains abutting on the perimeter of the circular disk 20 by providing a pull force for the extension arm 40 toward the circular disk 20. The fourth exemplary embodiment in FIG. 11 replaces the spring in the first exemplary embodiment with an elastic plate 65. When the extension arm 40 is in the second position shown in FIG. 11, the extension arm 40 deforms the elastic plate 65 to have a recovery force in direction F, which makes sure that the extension arm 40 maintains abutting on the perimeter of the circular disk 20.

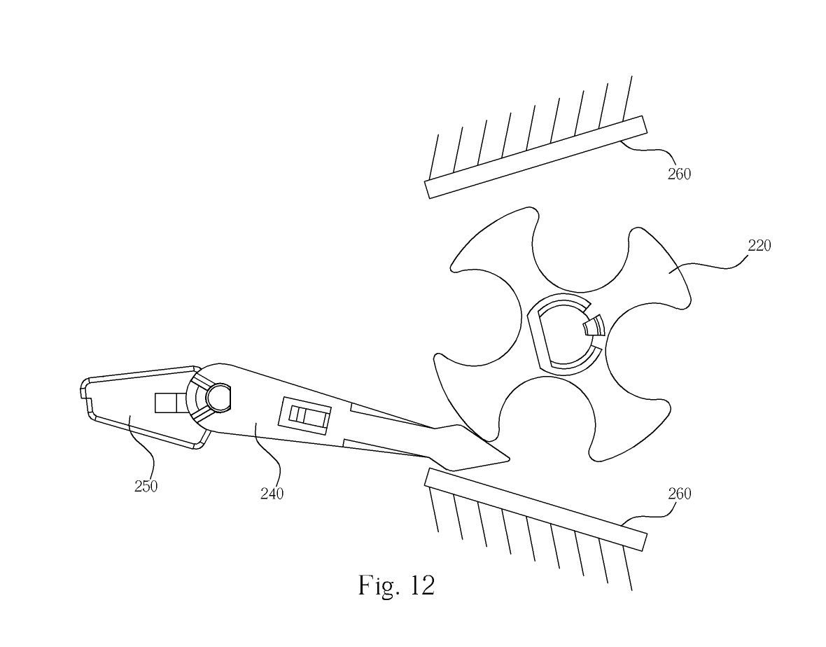

FIG. 12 is an illustration of a fifth exemplary embodiment of the paper route switching apparatus according to the present invention, which uses crosspieces 260 in the image system (not shown in the figure) for keeping the extension arm 240 abutting on the perimeter of the circular disk 220.

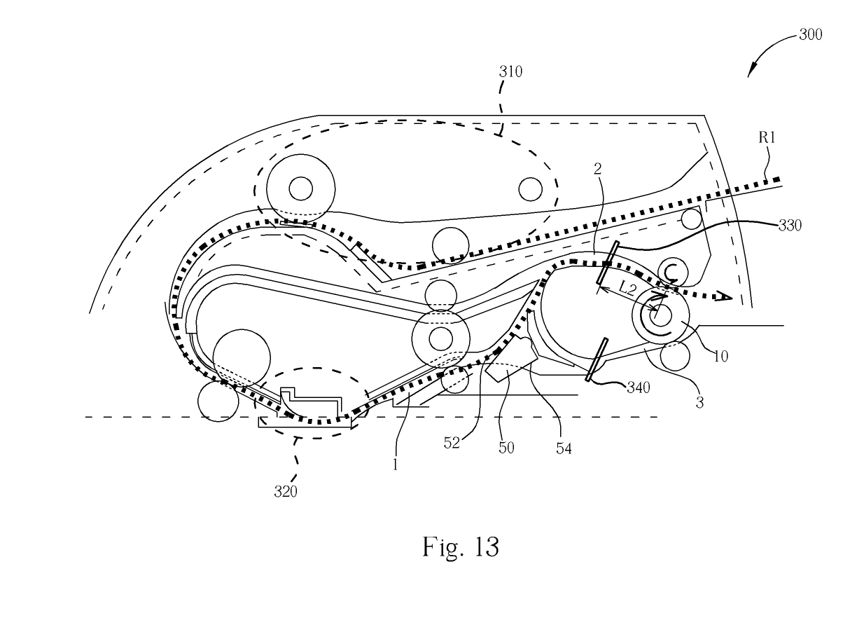

Please refer to FIG. 13 to FIG. 15, which illustrate an image system with paper route switching apparatus of the present invention. The image system 300 comprises a conveying roller set 310 for conveying the paper along route 1 in the paper conveying route of the image system 300. An image input/output core component 320 is configured in route 1 and can be a printhead of a printer or a light reading head of a scanner for scanning or printing on the paper when passing through route 1. Only the driving shaft 10 and the switch gate 50 of the aforementioned paper route switching apparatus in the image system 300 are shown in the figure for clarity. The first surface 52 and the second surface 54 of the switch gate 50 locate on route 2 and route 3 respectively when the switch gate 50 is in different positions. The image system 300 further comprises a route 1, a route 2, and a route 3. A first sensor 330 and a second sensor 340 lie on route 2 and route 3 respectively for sending a signal to the image system 300 for controlling the driving shaft 10 to alter the direction of rotation when detecting the end of the paper.

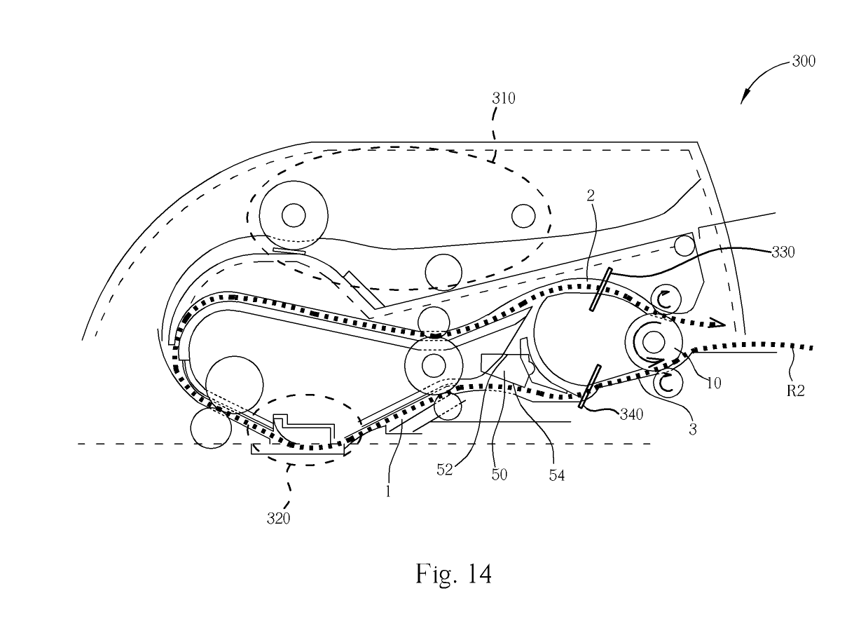

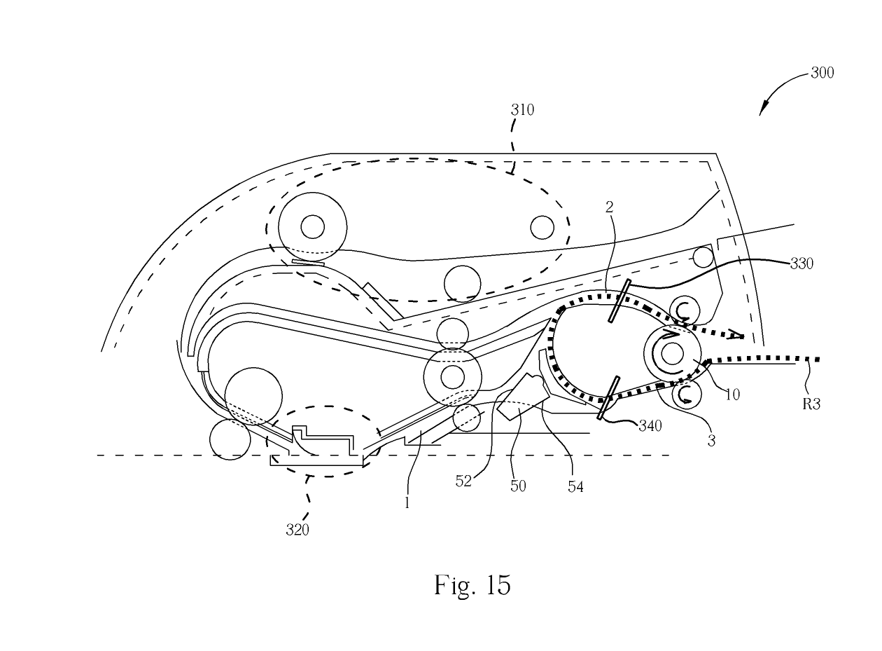

FIG. 13 illustrates a route R1 when the image system 300 performs input/output on the first side of the paper. When the paper proceeds along route R1 (from route 1 to route 2), the driving shaft 10 alters its direction of rotation as the first sensor 330 on route 2 detects the end of the paper; meanwhile, the switch gate 50 is guided from the first position in FIG. 4 to the second position in FIG. 5. To effectively speed up switching the switch gate 50, the length L1 in circumstance between the indentations 222 of the circular disk 220 is shorter than the distance L2, the distance from the first sensor 330 to the driving shaft 10. In FIG. 14, the paper proceeds along route R2, i.e., the paper passes through route 1 again, at which time the paper faces the image input/output core component 320 with its second side and since the switch gate 50 has been switched to the second position, route R2 represents route 1 to route 3 and the paper can be ejected out of the image system directly from route 3 for finishing a duplex paper convey. However, the image system in the present invention also has feature of paper sorting. After the second sensor 340 on route 3 detects the end of the paper, the driving shaft 10 alters its direction of rotation; meanwhile, the switch gate 50 is guided from the second position in FIG. 5 to the first position in FIG. 4, and then in FIG. 15, the paper proceeds along route R3, from route 3 to route 1, and leaves the image system 300 from route 1. The paper sorting feature of the image system 300 sorts the papers and maintains the original order of the original papers when more than one original paper enter the image system 300.

The paper route switching apparatus disclosed in the present invention uses a disk having one or more indentations and configured at one end of a driving shaft for interacting with an extension arm configured at a corresponding end of a switch shaft for switching the medium conveying route in an image system. When the driving shaft drives the disk to rotate along different directions, the indentations on the disk provide the extension arm room for the disk to guide the extension arm to switch its position between a first position and a second position. A plurality of switch gates on the switch shaft also switch to different positions corresponding to the extension arm such that the conveying route of a medium can be switched between a first route and a second route.

Those skilled in the art will readily observe that numerous modifications and alterations of the device and method may be made while retaining the teachings of the invention.

What is claimed is:

1. A paper route switching apparatus for switching the medium conveying route of an image system from a first route to a second route, the paper route switching apparatus comprising:
a driving shaft comprising a circular disk configured at one end of the driving shaft and capable of rotating with the driving shaft, the circular disk comprising an indentation; and
a switch shaft capable of selectively rotating to a first position or a second position, the switch shaft comprising:
an extension arm extending from one end of the switch shaft and abutting on the perimeter of the circular disk, capable of reaching into the indentation when the circular disk rotates with the driving shaft and being guided by the indentation for switching the switch shaft from the first position to the second position; and
a switch gate radially extending from the switch shaft and capable of selectively lying at the first route or the second route when the switch shaft selectively rotates to the first position or the second position.

2. The paper route switching apparatus of claim 1, wherein the switch gate comprises a first surface and a second surface, the first surface lying on the first route when the switch shaft lies in the first position and the second surface lying on the second route when the switch shaft lies in the second position.

3. The paper route switching apparatus of claim 1, further comprising a transformation gear set coupled to the driving shaft for changing the rotary speed of the driving shaft.

4. The paper route switching apparatus of claim 1, further comprising a recovery element connecting between the housing of the image system and the extension arm.

5. The paper route switching apparatus of claim 4, wherein the recovery element is a spring or an elastic plate.

6. The paper route switching apparatus of claim 1, further comprising a first crosspiece and a second crosspiece configured at the outer side of the circular disk for blocking the extension arm and keeping the switch shaft in the first position or the second position.

7. An image system having paper route switching apparatus and a first route, a second route and a third route, the image system comprising:
a conveying roller set for conveying an image medium to proceed in the first route;
a first sensor configured on the second route for detecting an end of the image medium; and
a paper route switching apparatus, comprising:
a driving shaft capable of rotating along a first direction or a second direction, comprising a circular disk configured at one end of the driving shaft and capable of rotating with the driving shaft, the circular disk comprising an indentation; and
a switch shaft capable of selectively rotating to a first position or a second position, the switch shaft comprising:
an extension arm extending from one end of the switch shaft and abutting on the perimeter of the circular disk, capable of reaching into the indentation when the circular disk rotates with the driving shaft; and
a switch gate radially extending from the switch shaft and capable of selectively lying at the second route or the third route when the switch shaft selectively rotates to the first position or the second position;
wherein when the driving shaft rotates along the first direction, the indentation is for guiding the extension arm and switching the switch shaft from the second position to the first position and the image medium proceeds from the first route to the second route; when the driving shaft rotates along the second direction, the indentation is for guiding the extension arm and switching the switch shaft from the first position to the second position and the image medium proceeds from the first route to the third route.

8. The image system of claim 7, wherein the switch gate comprises a first surface and a second surface, the first surface lying on the second route when the switch shaft lies in the first position and the second surface lying on the third route when the switch shaft lies in the second position.

9. The image system of claim 7, further comprising a transformation gear set coupled to the driving shaft for changing the rotary speed of the driving shaft.

10. The image system of claim 7, further comprising a recovery element connecting between the housing of the image system and the extension arm.

11. The image system of claim 10, wherein the recovery element is a spring or an elastic plate.

12. The image system of claim 7, further comprising a first crosspiece and a second crosspiece configured at the outer side of the circular disk for blocking the extension arm and keeping the switch shaft in the first position or the second position.

13. The image system of claim 7, further comprising a second sensor configured on the third route for detecting an end of the image medium, the driving shaft rotating along the first direction and the indentation guiding the extension arm and switching the switch shaft from the second position to the first position and the image medium proceeding from the third route to the second route when the second sensor detects the end of the image medium.
